(19) United States
(12) Patent Application Publication
(10) Pub. No.: US 2023/0149774 A1
(43) Pub. Date: May 18, 2023

(54) Handle Motion Counting Method and Terminal

(71) Applicant: Dongguan Chuan OptoElectronics Limited, Dongguan, Guangdong (CN)

(72) Inventor: Yiquan Liu, Dongguan, Guangdong (CN)

(21) Appl. No.: 16/979,538

(22) PCT Filed: Aug. 10, 2020
(86) PCT No.: PCT/CN2020/108058

§ 371 Date: Dec. 1, 2022

(30) Foreign Application Priority Data
Apr. 30, 2020 (CN) 202010365951.4

(51) Int. Cl. A63B 24/00; A63B 71/06; A63B 21/00

(52) U.S. Cl. CPC A63B 24/0062; A63B 71/0622; A63B 21/4035; A63B 2220/17; A63B 2220/34; A63B 2220/40; A63B 2225/02; A63B 2024/0065

(57) ABSTRACT

A handle motion counting method and terminal are disclosed. The method comprises: acquiring a handle type of a current exercise handle and real-time motion data of the current exercise handle within a preset time period; acquiring current handle type feature data corresponding to the current exercise handle according to the handle type of the current exercise handle; determining the real-time fitness action of the current exercise handle according to the matching condition of the real-time motion feature data and standard motion feature data of each fitness action in the current handle type feature data; acquiring single standard motion feature data of the real-time fitness action from the current handle type feature data, and obtaining the real-time number of the real-time fitness actions by calculation according to the single standard motion feature data and real-time motion feature data corresponding to real-time motion data subsequently received in each preset time period.

### TECHNICAL FIELD

The invention relates to the technical field of motion counting, in particular to a handle motion counting method and terminal.

### DESCRIPTION OF RELATED ART

With the improvement of living standard, people are attaching greater importance to their health, which prompts people at different ages to start to pay attention to their personnel health and life style. People in modern society tend to do exercise indoors rather than outdoors, such as in gyms or at home. Fitness exercises based on equipment such as skipping ropes, AB rollers and dumbbells need to be performed repeatedly by certain times to realize the fitness effect. It is difficult for users to remember the times of repetition in the exercise process, thus affecting the exercise effect.

### BRIEF SUMMARY OF THE INVENTION

### Technical Issue

The technical issue to be settled by the invention is to provide a handle motion counting method and terminal to realize counting of handle motions.

### Technical Solution to the Issue

### Technical Solution

The technical solution adopted by the invention to settle the aforesaid technical issue is as follows:

A handle motion counting method comprises the following steps:

S1: acquiring a handle type of a current exercise handle and real-time motion data of the current exercise handle within a preset time period, wherein the real-time motion data include real-time angular speed data and real-time acceleration data acquired by an internal six-axis gyroscope;

S2: acquiring current handle type feature data corresponding to the current exercise handle according to the handle type of the current exercise handle;

S3: extracting real-time motion feature data from the real-time motion data, and determining a real-time fitness action of the current exercise handle according to the matching condition of the real-time motion feature data and standard motion feature data of each fitness action in the current handle type feature data, wherein the standard motion feature data are extracted from pre-acquired standard motion data of each fitness action of each handle type; and

S4: acquiring single standard motion feature data of the real-time fitness action from the current handle type feature data, and obtaining the real-time number of the real-time fitness actions by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

Another technical solution adopted by the invention to settle the aforesaid technical issue is as follows:

A handle motion counting terminal comprises a memory, a processor, and a computer program which is stored in the memory and is to be run on the processor, wherein the processor executes the computer program to implement the following steps:

S1: acquiring a handle type of a current exercise handle and real-time motion data of the current exercise handle within a preset time period, wherein the real-time motion data include real-time angular speed data and real-time acceleration data acquired by an internal six-axis gyroscope;

S2: acquiring current handle type feature data corresponding to the current exercise handle according to the handle type of the current exercise handle;

S3: extracting real-time motion feature data from the real-time motion data, and determining a real-time fitness action of the current exercise handle according to the matching condition of the real-time motion feature data and standard motion feature data of each fitness action in the current handle type feature data, wherein the standard motion feature data are extracted from pre-acquired standard motion data of each fitness action of each handle type; and

S4: acquiring single standard motion feature data of the real-time fitness action from the current handle type feature data, and obtaining the real-time number of the real-time fitness actions by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

### Beneficial Effects of the Invention

### Beneficial Effects

The invention has the following beneficial effects: according to the handle motion counting method and terminal, when a user does exercises with the current exercise handle, the handle type of the current exercise handle and the real-time motion data acquired in real time are reported to the counting terminal, the counting terminal recognizes the handle type and the real-time fitness action, and finally, counting is carried out according to single standard motion feature data of the real-time fitness action, so that the handle motions are counted; wherein, the standard motion feature data are extracted from pre-acquired standard motion data of each fitness action of each handle type, the single standard motion feature data include all motion feature data for completing one corresponding fitness action, and all the motion feature data are sorted in a time sequence, that is, data for recognition are true data, which are input in advance in real time, of different features corresponding to each fitness action, so that more accurate counting is realized.

### BRIEF DESCRIPTION OF THE SEVERAL VIEWS OF THE DRAWINGS

### Description of the Drawings

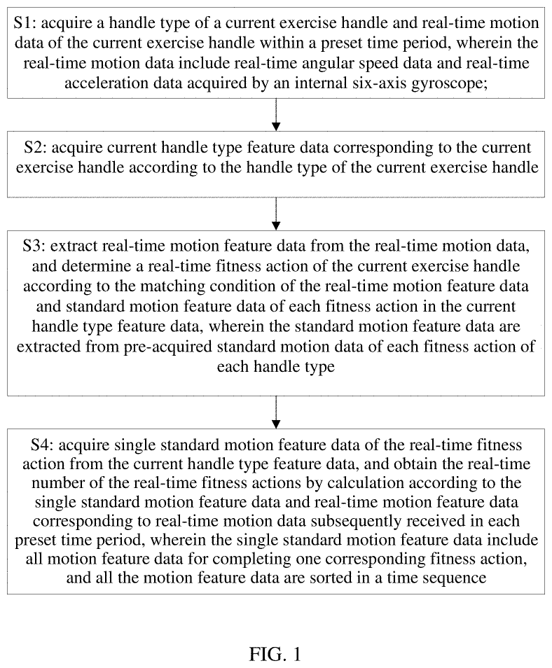

FIG. 1 is a flow diagram of a handle motion counting method in one embodiment of the invention;

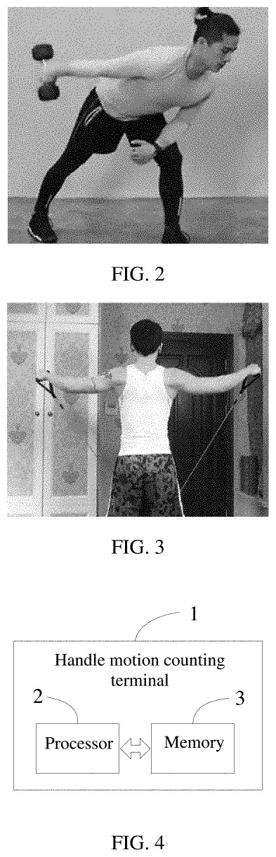

FIG. 2 is a schematic diagram of a fitness action involved in the embodiment of the invention;

FIG. 3 is a schematic diagram of another fitness action involved in the embodiment of the invention;

FIG. 4 is a structural diagram of a handle motion counting terminal in the embodiment of the invention.

### REFERENCE SIGNS

1, handle motion counting terminal; 2, processor; 3, memory.

### DETAILED DESCRIPTION OF THE INVENTION

### Embodiments of the Invention

The technical contents, purposes and effects of the invention are expounded below in conjunction with the embodiments and accompanying drawings.

Referring to FIG. 1, a handle motion counting method comprises the following steps:

S1: a handle type of a current exercise handle and real-time motion data of the current exercise handle within a preset time period are acquired, wherein the real-time motion data include real-time angular speed data and real-time acceleration data acquired by an internal six-axis gyroscope;

S2: current handle type feature data corresponding to the current exercise handle are acquired according to the handle type of the current exercise handle;

S3: real-time motion feature data are extracted from the real-time motion data, and a real-time fitness action of the current exercise handle is determined according to the matching condition of the real-time motion feature data and standard motion feature data of each fitness action in the current handle type feature data, wherein the standard motion feature data are extracted from pre-acquired standard motion data of each fitness action of each handle type; and

S4: single standard motion feature data of the real-time fitness action are acquired from the current handle type feature data, and the real-time number of the real-time fitness actions is obtained by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

From the above description, the invention has the following beneficial effects: when a user does exercises with the current exercise handle, the handle type of the current exercise handle and the real-time motion data acquired in real time are reported to the counting terminal, the counting terminal recognizes the handle type and the real-time fitness action, and finally, counting is carried out according to single standard motion feature data of the real-time fitness action, so that the handle motions are counted; wherein, the standard motion feature data are extracted from pre-acquired standard motion data of each fitness action of each handle type, the single standard motion feature data include all motion feature data for completing one corresponding fitness action, and all the motion feature data are sorted in a time sequence, that is, data for recognition are true data, which are input in advance in real time, of different features corresponding to each fitness action, so that more accurate counting is realized.

Furthermore, the standard motion feature data in Step S3 are obtained specifically through the following steps:

In a data input stage, M pieces of input motion feature data of N input users completing the first fitness action with the same exercise handle are acquired, and common motion feature data are extracted from the M pieces of input motion feature data to serve as the standard motion feature data corresponding to the first fitness action, wherein M is greater than N, and each input user completes the first fitness action at least once; and

In a data test stage, multiple pieces of test motion feature data of each test user completing different fitness actions with the same exercise handle are acquired; whether or not each piece of test motion feature data corresponds to the first fitness action is determined according to the standard motion feature data; if each piece of test motion feature data can be accurately determined, a test succeeds; otherwise, an input user is added or an extraction strategy is adjusted until the test succeeds.

From the above description, input data of multiple input users are collected multiple times to weaken the influence of individual differences on feature data, and the acquired standard motion feature data are tested to guarantee that users with different physical fitness data can be accurately recognized according to finally obtained standard motion feature data.

Furthermore, in the data input stage, the following steps are also implemented:

Input physical fitness data of each input user are collected in real time;

The M pieces of input motion feature data are classified according to different input users to obtain N input motion feature data sets; and

The input physical fitness data and the input motion feature data set of each input user are taken as a set of training parameters, and individual difference data of the first fitness action are obtained according to N sets of training parameters, wherein the individual difference data are associations between the physical fitness data and the motion feature data.

In the data test stage, the following steps are also implemented:

Test physical fitness data of each test user and test motion feature data of each test user completing the first fitness action are collected in real time;

Simulated motion feature data of each test user are obtained according to the test physical fitness data of the test user and the individual difference data of the first fitness action; and

Whether or not a difference between the test motion feature data for completing the first fitness action and the simulated motion feature data of each test user is within a consistency threshold is determined; if so, the test succeeds; otherwise, an input user is added or an extraction strategy is adjusted until the test succeeds.

In an application stage from Step S1 to Step S4, the following step is also implemented:

Identity information of a user entering an area where the current exercise handle is located is collected in real time; if the identity information of the user indicates that the user enters the area where the current exercise handle is located for the first time, physical fitness data of the user corresponding to the identity information of the user are acquired;

After Step S4, the following steps are also implemented:

The last real-time number is used as a final number if the real-time number is not updated after a preset interval or a difference between the real-time motion feature data of two successive motions exceeds a preset user threshold, and the real-time number is updated to 0;

Identify information of all users in the area where the current exercise handle is located within the whole time period corresponding to the final number is acquired to obtain a first identity information set, and user physical fitness data corresponding to each piece of user identity information in the first identity information set are acquired to obtain a first physical fitness data set;

The individual difference data of the real-time fitness action are acquired, and a first user, that best matches the real-time motion feature data, is selected from the first physical fitness data set according to the individual difference data of the real-time fitness action; and

A preset interface is generated according to the final number and is sent to the first user.

From the above description, in the data input stage, the physical fitness data of each user are collected, and different users have common motion feature data as well as different motion feature data, wherein the common motion feature data are used as standard motion feature data to realize accurate action recognition and counting, and the different motion feature data are used as individual difference data to distinguish the number of the motions of different users; by determining the identify information of users entering the fitness area, the matching range can be narrowed to guarantee the matching efficiency and accuracy, so that when doing exercises in a controllable public area such as a gym, users can automatically receive exercise data of themselves in the current area.

Furthermore, the first user, which best matches the real-time motion feature data, is selected from the first physical fitness set according to the individual difference data of the real-time fitness action specifically through the following steps:

Whether or not the real-time fitness action is a single-hand operation is determined; if so, single real-time motion feature data are acquired from the real-time motion feature data every time the real-time fitness action is completed, all the single real-time motion feature data are analyzed to obtain a single motion track and a single speed variation corresponding to each piece of single real-time motion feature data, an overall track variation, an overall interval variation and an overall speed variation are obtained according to the single motion tracks and the single speed variations of all the single real-time motion feature data, and the single motion tracks, the single speed variations, the overall track variation, the overall interval variation and the overall speed variation are used as real-time user recognition data;

User physical fitness data are extracted piece by piece from the first physical fitness data set, wherein the user physical fitness data include height, length of arms and legs, and length of upper arms;

A matching degree between each piece of user physical fitness data and the real-time user data is determined according to the individual difference data to obtain the first user with the highest matching degree; or

If the real-time fitness action is a two-hand operation, two sets of real-time motion feature data are acquired, and real-time user recognition data including two sets of single motion tracks, single speed variations, overall track variations, overall interval variations and overall speed variations as well as a distance variation of the two sets of real-time motion data at the same time point are obtained;

User physical fitness data are extracted piece by piece from the first physical fitness data set, wherein the user physical fitness data include height, length of arms and legs, arm span, and length of upper arms; and

A matching degree between each piece of user physical fitness data and the real-time user data is determined according to the individual difference data to obtain the first user with the highest matching degree.

From the above description, due to the fact that different users have different physical fitness data such as height, length of legs and arms, arm span and length of upper arms, the motion tracks, speed variations and time intervals of different users completing the same fitness action may vary drastically; and the motion tracks, speed variations and time intervals of users with similar physical fitness data may also be significantly different due to their fitness habits. For example, the height has an influence on the motion track and the single motion time, the physical strength has an influence on the speed variation, the personal habit has an influence on the speed variation and the time interval. Thus, the user corresponding to the real-time motion data can be obtained more accurately according to the physical fitness data of each user and the pre-trained individual difference data.

Furthermore, the current exercise handle is a pulling rope handle, a dumbbell handle or a butterfly rope handle.

From the above description, the handle motion counting method is suitable for real-time counting and transmission of various handle motions.

Referring to FIG. 4, a handle motion counting terminal comprises a memory, a processor, and a computer program which is stored in the memory and is to be run on the processor, and the processor executes the computer program to implement the following steps:

S1: a handle type of a current exercise handle and real-time motion data of the current exercise handle within a preset time period are acquired, wherein the real-time motion data include real-time angular speed data and real-time acceleration data acquired by an internal six-axis gyroscope;

S2: current handle type feature data corresponding to the current exercise handle are acquired according to the handle type of the current exercise handle;

S3: real-time motion feature data are extracted from the real-time motion data, a real-time fitness action of the current exercise handle is determined according to the matching condition of the real-time motion feature data and the standard motion feature data of each fitness action in the current handle type feature data, wherein the standard motion feature data are extracted from pre-acquired standard motion data of each fitness action in each handle type; and

S4: single standard motion feature data of the real-time fitness action are acquired from the current handle type feature data, and the real-time number of the real-time fitness actions is obtained by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

From the above description, the invention has the following beneficial effects: when a user does exercises with the current exercise handle, the handle type of the current exercise handle and the real-time motion data acquired in real time are reported to the counting terminal, the counting terminal recognizes the handle type and the real-time fitness action, and finally, counting is carried out according to single standard motion feature data of the real-time fitness action, so that the handle motions are counted; wherein, the standard motion feature data are extracted from pre-acquired standard motion data of each fitness action of each handle type, the single standard motion feature data include all motion feature data for completing one corresponding fitness action, and all the motion feature data are sorted in a time sequence, that is, data for recognition are true data, which are input in advance in real time, of different features corresponding to each fitness action, so that more accurate counting is realized.

Furthermore, when the standard motion feature data in Step S3 are obtained, the processor executes the computer program to further implement the following steps:

In a data input stage, M pieces of input motion feature data of N input users completing the first fitness action with the same exercise handle are acquired, and common motion feature data are extracted from the M pieces of input motion feature data to serve as the standard motion feature data corresponding to the first fitness action, wherein M is greater than N, and each input user completes the first fitness action at least once; and

In a data test stage, multiple pieces of test motion feature data of each test user completing different fitness actions with the same exercise handle are acquired; whether or not each piece of test motion feature data corresponds to the first fitness action is determined according to the standard motion feature data; if each piece of test motion feature data can be accurately determined, a test succeeds; otherwise, an input user is added or an extraction strategy is adjusted until the test succeeds.

From the above description, input data of multiple input users are collected multiple times to weaken the influence of individual differences on feature data, and the acquired standard motion feature data are tested to guarantee that users with different physical fitness data can be accurately recognized according to finally obtained standard motion feature data.

Furthermore, in the data input stage, the processor executes the computer program to further implement the following steps:

Input physical fitness data of each input user are collected in real time;

The M pieces of input motion feature data are classified according to different input users to obtain N input motion feature data sets; and

The input physical fitness data and the input motion feature data set of each input user are taken as a set of training parameters, and individual difference data of the first fitness action are obtained according to N sets of training parameters, wherein the individual difference data are associations between the physical fitness data and the motion feature data.

In the data test stage, the processor executes the computer program to further implement the following steps:

Test physical fitness data of each test user and test motion feature data of each test user completing the first fitness action are collected in real time;

Simulated motion feature data of each test user are obtained according to the test physical fitness data of the test user and the individual difference data of the first fitness action; and

Whether or not a difference between the test motion feature data for completing the first fitness action and the simulated motion feature data of each test user is within a consistency threshold is determined; if so, the test succeeds; otherwise, an input user is added or an extraction strategy is adjusted until the test succeeds.

In an application stage from Step S1 to Step S4, the processor executes the computer program to further implement the following step:

Identity information of a user entering an area where the current exercise handle is located is collected in real time; if the identity information of the user indicates that the user enters the area where the current exercise handle is located for the first time, physical fitness data of the user corresponding to the identity information of the user are acquired;

In the application stage from Step S1 to Step S4, the processor executes the computer program to further implement the following steps after Step S4:

The last real-time number is used as a final number if the real-time number is not updated after a preset interval or a difference between the real-time motion feature data of two successive motions exceeds a preset user threshold, and the real-time number is updated to 0;

Identify information of all users in the area where the current exercise handle is located within the whole time period corresponding to the final number is acquired to obtain a first identity information set, and user physical fitness data corresponding to each piece of user identity information in the first identity information set are acquired to obtain a first physical fitness data set;

The individual difference data of the real-time fitness action are acquired, and a first user, that best matches the real-time motion feature data, is selected from the first physical fitness data set according to the individual difference data of the real-time fitness action; and

A preset interface is generated according to the final number and is sent to the first user.

From the above description, in the data input stage, the physical fitness data of each user are collected, and different users have common motion feature data as well as different motion feature data, wherein the common motion feature data are used as standard motion feature data to realize accurate action recognition and counting, and the different motion feature data are used as individual difference data to distinguish the number of the motions of different users; by determining the identify information of users entering the fitness area, the matching range can be narrowed to guarantee the matching efficiency and accuracy, so that when doing exercises in a controllable public area such as a gym, users can automatically receive exercise data of themselves in the current area.

Furthermore, the process executes the computer program to implement the step “the first user, which best matches the real-time motion feature data, is selected from the first physical fitness set according to the individual difference data of the real-time fitness action” specifically as follows:

Whether or not the real-time fitness action is a single-hand operation is determined; if so, single real-time motion feature data are acquired from the real-time motion feature data every time the real-time fitness action is completed, all the single real-time motion feature data are analyzed to obtain a single motion track and a single speed variation corresponding to each piece of single real-time motion feature data, an overall track variation, an overall interval variation and an overall speed variation are obtained according to the single motion tracks and the single speed variations of all the single real-time motion feature data, and the single motion tracks, the single speed variations, the overall track variation, the overall interval variation and the overall speed variation are used as real-time user recognition data;

User physical fitness data are extracted piece by piece from the first physical fitness data set, wherein the user physical fitness data include height, length of arms and legs, and length of upper arms;

A matching degree between each piece of user physical fitness data and the real-time user data is determined according to the individual difference data to obtain the first user with the highest matching degree; or

If the real-time fitness action is a two-hand operation, two sets of real-time motion feature data are acquired, and real-time user recognition data including two sets of single motion tracks, single speed variations, overall track variations, overall interval variations and overall speed variations as well as a distance variation of the two sets of real-time motion data at the same time point are obtained;

User physical fitness data are extracted piece by piece from the first physical fitness data set, wherein the user physical fitness data include height, length of arms and legs, arm span, and length of upper arms; and

A matching degree between each piece of user physical fitness data and the real-time user data is determined according to the individual difference data to obtain the first user with the highest matching degree.

From the above description, due to the fact that different users have different physical fitness data such as height, length of legs and arms, arm span and length of upper arms, the motion tracks, speed variations and time intervals of different users completing the same fitness action may vary drastically; and the motion tracks, speed variations and time intervals of users with similar physical fitness data may also be significantly different due to their fitness habits. For example, the height has an influence on the motion track and the single motion time, the physical strength has an influence on the speed variation, the personal habit has an influence on the speed variation and the time interval. Thus, the user best matches the real-time motion data can be obtained according to the physical fitness data of each user and the pre-trained individual difference data.

Furthermore, the current exercise handle is a pulling rope handle, a dumbbell handle or a butterfly rope handle.

From the above description, the invention has the following beneficial effects: when a user does exercises with the current exercise handle, the handle type of the current exercise handle and the real-time motion data acquired in real time are reported to the counting terminal, the counting terminal recognizes the handle type and the real-time fitness action, and finally, counting is carried out according to single standard motion feature data of the real-time fitness action, so that the handle motions are counted; wherein, the standard motion feature data are extracted from pre-acquired standard motion data of each fitness action of each handle type, the single standard motion feature data include all motion feature data for completing one corresponding fitness action, and all the motion feature data are sorted in a time sequence, that is, data for recognition are true data, which are input in advance in real time, of different features corresponding to each fitness action, so that more accurate counting is realized.

From the above description, the handle motion counting terminal is suitable for real-time counting and transmission of various handle motions.

Referring to FIG. 1, Embodiment of the invention is as follows:

In this embodiment, the exercise handle is a pulling rope handle, a dumbbell handle or a butterfly rope handle, wherein the pulling rope handle can be used to perform the fitness actions such as standing rowing, lateral raising, standing shoulder pushing and backward bending and stretching, and FIG. 3 shows the fitness action of lateral raising; the dumbbell handle is used to perform the fitness actions such as biceps curls, single-arm arm bending and stretching, backward bending and stretching and single-leg stretching, and FIG. 2 shows the fitness action of single-arm arm bending and stretching; and the butterfly rope handle is used to perform the fitness actions such as standing hip stretching, lying abdomen stretching, sitting biceps stretching and sitting bowing. The fitness actions correspond to different motion feature data due to their different body movements.

Specifically, a handle motion counting method for in this embodiment comprises a data input stage, a data test stage and an application stage.

In this embodiment, the data input stage specifically includes the following steps:

M pieces of input motion feature data of N input users completing a first fitness action with the same exercise handle are acquired, and common motion feature data are extracted from the M pieces of input motion feature data to serve as standard motion feature data corresponding to the first fitness action, wherein M is greater than N, and each input user completes the first fitness action at least once; for example, when multiple users perform the fitness action of lateral raising in FIG. 3, data of the different users performing lateral raising are tested separately, so that multiple pieces of motion feature data of the different users performing the same fitness action are collected for feature extraction to eliminate the influences of individual differences on a result;

Input physical fitness data of each input user are collected in real time, the M pieces of input motion feature data are sorted according to different users to obtain N input motion feature data sets, the input physical fitness data and the input motion feature data set of each input user are taken as a set of training parameters, and individual difference data of the first fitness action are obtained according to N sets of training parameters, wherein the individual difference data indicate associations between the physical fitness data and the motion feature data. Due to the individual differences of different users in physical fitness, the motion data of different users performing the same action will be different. In this embodiment, common features of different users are used as the standard motion feature data to realize accurate action recognition and counting, and distinctive features of different users are used as individual difference data to distinguish the number of actions performed by different users.

Wherein, a neural network model can be used to extract the standard motion feature data and to train the individual difference data, and all data will be processed subsequently through the trained neural network model.

In this embodiment, the data test stage specifically includes the following steps:

Multiple pieces of test motion feature data of each test user completing different fitness actions with the same exercise handle are acquired; whether or not each piece of test motion feature data corresponds to the first fitness action is determined according to the standard motion feature data; if each piece of test motion feature data can be accurately determined, a test succeeds; otherwise, an input user or an extraction strategy is adjusted until the test succeeds; and

Test physical fitness data of each test user and test motion feature data of each user completing the first fitness action are collected in real time; simulated motion feature data of each test user are obtained according to the test physical fitness data of each user and the individual difference data; whether or not a difference between the test motion feature data for completing the first fitness action and the simulated motion feature data of each test user is within a preset consistency threshold is determined; if yes, the test succeeds; otherwise, an input user is added or an extraction strategy is adjusted until the test succeeds; and finally, the successfully tested neural network model is output for subsequent processing.

In this embodiment, the application stage comprises the following steps:

Identity information of a user entering the area where the exercise handle is located is collected in real time; if the identify information of the user indicates that the user enters the area where the exercise handle is located for the first time, physical fitness data of the user corresponding to the identify information of the user are acquired. For example, the time period of a user in a gym can be recognized by checking a card registration or through a camera at the entrance when the user enters the gym;

S1: a handle type of a current exercise handle and real-time motion data of the current exercise handle within a preset time period are acquired, wherein the real-time motion data include real-time angular speed data and real-time acceleration data acquired by an internal six-axis gyroscope; the handle type is pre-stored in the exercise handle, or the handle type of the exercise handle is recognized through a series number of the exercise handle or in other available ways; the six-axis gyroscope comprises a three-axis gyroscope and a three-axis accelerometer, the motion state and attitude of an object can be determined according to the real-time angular speed data and the real-time acceleration data acquired by the six-axis gyroscope, and different fitness actions can be recognized according to different states and attitudes of the object;

S2: current handle type feature data corresponding to the current exercise handle are acquired according to the handle type of the current exercise handle, for example, the current exercise handle is a pulling rope handle;

S3: real-time motion feature data are extracted from the real-time motion data, a real-time fitness action of the current exercise handle is determined according to the matching condition of the real-time motion feature data and the standard motion feature data of each fitness action in the current handle type feature data, wherein the standard motion feature data are extracted from pre-acquired standard motion data of each fitness action in each handle type; and the specific fitness action, such as lateral raising in FIG. 3, performed through the pulling rope handle is determined by analyzing the acquired real-time motion feature data;

S4: single standard motion feature data of the real-time fitness action are extracted from the current handle type feature data, and the real-time number of the real-time fitness actions is obtained by calculation according to the single standard motion feature data and real-time motion feature data corresponding to real-time motion data received in each preset time period, wherein the single standard motion feature data include all motion feature data for completing one corresponding fitness action, and all the motion feature data are sorted in a time sequence; and on the basis of the continuous real-time motion feature data, the number of motions can be well calculated according to the single standard motion feature data and repeated motion feature data in the continuous real-time motion feature data. For example, feature data of lateral raising in FIG. 3 includes single standard motion feature data obtained in the process that pulling rope handles are stretched towards two sides from initial positions to be flush with the shoulders and finally return to the initial positions, and accurate counting can be realized according to the repetition of the single standard motion feature data in the real-time motion data;

The last real-time number is used as a final number if the real-time number is not updated after a preset interval or a difference between the real-time motion feature data of two successive motions exceeds a preset user threshold, and the real-time number is updated to 0, wherein if the real-time number is not updated after the preset interval, it is considered that the current user completes the exercise; if the difference between the real-time motion feature data of two successive motions exceeds the preset user threshold, it is considered that the current exercise handle is used by another user;

Identify information of all users in the area where the current exercise handle is located within the whole time period corresponding to the final number is acquired to obtain a first identity information set, and user physical fitness data corresponding to each piece of user identity information in the first identity information set are acquired to obtain a first physical fitness data set, wherein if the whole time period corresponding to the final number is from half past eight to nine o'clock at night, identity information of all users in the gym from half past eight to nine o'clock at night will be collected, and then user physical fitness data of all users within this time period are acquired;

The individual difference data of the real-time fitness action are acquired, and a first user, that best matches the real-time motion feature data, is selected from the first physical fitness data set according to the individual difference data of the real-time fitness action.

In this embodiment, all handles can be associated, for example, two exercise handles on a butterfly rope and all dumbbells with the same weight can be associated in advance, so that a subsequent two-hand operation performed by a user can be determined based on the associations and motion feature data. The distinctions of a single-handle operation and a two-handle operation are as follows:

Whether or not the real-time fitness action is a single-hand operation is determined; if so, single real-time motion feature data are acquired from the real-time motion feature data every time the real-time fitness action is completed, all the single real-time motion feature data are analyzed to obtain a single motion track and a single speed variation corresponding to each piece of single real-time motion feature data, an overall track variation, an overall interval variation and an overall speed variation are obtained according to the single motion tracks and the single speed variations of all the single real-time motion feature data, and the single motion tracks, the single speed variations, the overall track variation, the overall interval variation and the overall speed variation are used as real-time user recognition data;

User physical fitness data are extracted piece by piece from the first physical fitness data set, wherein the user physical fitness data include height, length of arms and legs, and length of upper arms;

A matching degree between each piece of user physical fitness data and the real-time user data is determined according to the individual difference data to obtain the first user with the highest matching degree; or

If the real-time fitness action is a two-hand operation, two sets of real-time motion feature data are acquired, and real-time user recognition data including two sets of single motion tracks, single speed variations, overall track variations, overall interval variations and overall speed variations as well as a distance variation of the two sets of real-time motion data at the same time point are obtained;

User physical fitness data are extracted piece by piece from the first physical fitness data set, wherein the user physical fitness data include height, length of arms and legs, arm span, and length of upper arms; and

A matching degree between each piece of user physical fitness data and the real-time user data is determined according to the individual difference data to obtain the first user with the highest matching degree.

A preset interface is generated according to the final number and is sent to the first user.

Wherein, corresponding illustrative pictures may be set on the preset interface and can be preset to correspond or not correspond to fitness actions, and the preset interface may include the final number and the parameters such as fitness time, energy consumption. Meanwhile, the user may do exercises with multiple exercise handles, sin this case, the final number corresponding to each exercise handle can be obtained, and all the final numbers may be integrated on one interface or may be separated. Thus, in other equivalent embodiments, the preset interface can be customized according to actual requirements.

Referring to FIG. 4, Embodiment 2 of the invention is as follows:

A handle motion counting terminal 1 comprises a memory 3, a processor 2, and a computer program which is stored in the memory 3 and is able to run on the processor 2, wherein the processor 2 executes the computer program to implement the steps in Embodiment 1.

According to the handle motion counting method and terminal, in the data input stage, the physical fitness data of multiple input users are collected, and true motion data of the corresponding action are collected, wherein the motion feature data of different users have common feature points and distinctive feature points, the common feature points of multiple motion data of multiple users are used as standard motion feature data to realize accurate action recognition and counting, the distinctive feature points of the multiple users are used as the individual difference data to distinguish the number of motions performed by different users. When a user does exercises with the current exercise handle, the handle type of the current exercise handle and the real-time motion data acquired in real time are reported to the counting terminal, the counting terminal recognizes the handle type and the real-time fitness action to narrow the matching range according to determined identity information of a user entering a fitness area, and finally, counting is carried out according to single standard motion feature data of the real-time fitness action, so that rapider and more accurate counting of handle motions is realized.

The above embodiments are merely illustrative ones of the invention, and are not intended to limit the patent scope of the invention. All equivalent transformations obtained according to the contents in the specification and accompanying drawings, or direct or indirect applications to relevant technical fields should also fall within the patent protection scope of the invention.

1. A handle motion counting method, comprising following steps:
S1: acquiring a handle type of a current exercise handle and real-time motion data of the current exercise handle within a preset time period, wherein the real-time motion data include real-time angular speed data and real-time acceleration data acquired by an internal six-axis gyroscope;
S2: acquiring current handle type feature data corresponding to the current exercise handle according to the handle type of the current exercise handle;
S3: extracting real-time motion feature data from the real-time motion data, and determining a real-time fitness action of the current exercise handle according to a matching condition of the real-time motion feature data and standard motion feature data of each fitness action in the current handle type feature data, wherein the standard motion feature data are extracted from pre-acquired standard motion data of each fitness action of each handle type; and
S4: acquiring single standard motion feature data of the real-time fitness action from the current handle type feature data, and obtaining real-time number of the real-time fitness actions by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

2. The handle motion counting method according to claim 1, wherein the standard motion feature data in Step S3 are obtained specifically through the following steps:
in a data input stage, acquiring M pieces of input motion feature data of N input users completing a first fitness action with same exercise handle, and extracting common motion feature data from the M pieces of input motion feature data to serve as the standard motion feature data corresponding to the first fitness action, wherein M is greater than N, and each said input user completes the first fitness action at least once; and
in a data test stage, acquiring multiple pieces of test motion feature data of each test user completing different fitness actions with the same exercise handle; determining whether or not each piece of test motion feature data corresponds to the first fitness action according to the standard motion feature data; if each piece of test motion feature data can be accurately determined, determining that a test succeeds; otherwise, adding an input user or adjusting an extraction strategy until the test succeeds.

3. The handle motion counting method according to claim 2, wherein in the data input stage, the following steps are also implemented:
collecting input physical fitness data of each said input user in real time;
classifying the M pieces of input motion feature data according to different input users to obtain N input motion feature data sets;
taking the input physical fitness data and the input motion feature data set of each said input user as a set of training parameters, and obtaining individual difference data of the first fitness action according to N sets of training parameters, wherein the individual difference data are associations between the physical fitness data and the motion feature data; and
in the data test stage, the following steps are also implemented:
collecting test physical fitness data of each said test user and test motion feature data of each said test user completing the first fitness action in real time;
obtaining simulated motion feature data of each said test user according to the test physical fitness data of the test user and the individual difference data of the first fitness action;
judging whether or not a difference between the test motion feature data for completing the first fitness action and the simulated motion feature data of each said test user is within a consistency threshold; if so, determining that a test succeeds; otherwise, adding an input user or adjusting an extraction strategy until the test succeeds; and
in an application stage from Step S1 to Step S4, the following step is also implemented:
collecting identity information of a user entering an area where the current exercise handle is located in real time; if the identity information of the user indicates that the user enters the area where the current exercise handle is located for the first time, acquiring physical fitness data of the user corresponding to the identity information of the user;
after Step S4, the following steps are also implemented:
using last real-time number as a final number if the real-time number is not updated after a preset interval or a difference between the real-time motion feature data of two successive motions exceeds a preset user threshold, and updating the real-time number to 0;
acquiring identify information of all users in the area where the current exercise handle is located within a whole time period corresponding to the final number to obtain a first identity information set, and acquiring user physical fitness data corresponding to each piece of user identity information in the first identity information set to obtain a first physical fitness data set;
acquiring the individual difference data of the real-time fitness action, and selecting a first user, that best matches the real-time motion feature data, from the first physical fitness data set according to the individual difference data of the real-time fitness action; and
generating a preset interface according to the final number, and sending the preset interface to the first user.

4. The handle motion counting method according to claim 3, wherein selecting a first user, that best matches the real-time motion feature data, from the first physical fitness data set according to the individual difference data of the real-time fitness action specifically comprises the following steps:
determining whether or not the real-time fitness action is a single-hand operation; if so, acquiring single real-time motion feature data from the real-time motion feature data every time the real-time fitness action is completed, analyzing all the single real-time motion feature data to obtain a single motion track and a single speed variation corresponding to each piece of single real-time motion feature data, obtaining an overall track variation, an overall interval variation and an overall speed variation according to the single motion tracks and the single speed variations of all the single real-time motion feature data, and using the single motion tracks, the single speed variations, the overall track variation, the overall interval variation and the overall speed variation as real-time user recognition data;
extracting user physical fitness data piece by piece from the first physical fitness data set, wherein the user physical fitness data include height, length of arms and legs, and length of upper arms;
determining a matching degree between each piece of user physical fitness data and the real-time user data according to the individual difference data to obtain the first user with highest matching degree; or
if the real-time fitness action is a two-hand operation, acquiring two sets of real-time motion feature data, and obtaining real-time user recognition data including two sets of single motion tracks, single speed variations, overall track variations, overall interval variations and overall speed variations as well as a distance variation of the two sets of real-time motion data at a same time point;
extracting user physical fitness data piece by piece from the first physical fitness data set, wherein the user physical fitness data include height, length of arms and legs, arm span, and length of upper arms; and
determining a matching degree between each piece of user physical fitness data and the real-time user data according to the individual difference data to obtain the first user with a highest matching degree.

5. The handle motion counting method according to claim 1, wherein the current exercise handle is a pulling rope handle, a dumbbell handle or a butterfly rope handle.

6. A handle motion counting terminal, comprising a memory, a processor, and a computer program which is stored in the memory and is to be run on the processor, wherein the processor executes the computer program to implement following steps:
S1: acquiring a handle type of a current exercise handle and real-time motion data of the current exercise handle within a preset time period, wherein the real-time motion data include real-time angular speed data and real-time acceleration data acquired by an internal six-axis gyroscope;
S2: acquiring current handle type feature data corresponding to the current exercise handle according to the handle type of the current exercise handle;
S3: extracting real-time motion feature data from the real-time motion data, and determining a real-time fitness action of the current exercise handle according to a matching condition of the real-time motion feature data and standard motion feature data of each fitness action in the current handle type feature data, wherein the standard motion feature data are extracted from pre-acquired standard motion data of each fitness action of each handle type; and
S4: acquiring single standard motion feature data of the real-time fitness action from the current handle type feature data, and obtaining a real-time number of the real-time fitness actions by calculation according to the single standard motion feature data and real-time motion feature data corresponding to real-time motion data subsequently received in each preset time period, wherein the single standard motion feature data include all motion feature data for completing one corresponding fitness action, and all the motion feature data are sorted in a time sequence.

7. The handle motion counting terminal according to claim 6, wherein when the standard motion feature data in Step S3 are obtained, the processor executes the computer program to further implement the following steps:
in a data input stage, acquiring M pieces of input motion feature data of N input users completing a first fitness action with same exercise handle, and extracting common motion feature data from the M pieces of input motion feature data to serve as the standard motion feature data corresponding to the first fitness action, wherein M is greater than N, and each said input user completes the first fitness action at least once; and
in a data test stage, acquiring multiple pieces of test motion feature data of each test user completing different fitness actions with the same exercise handle; determining whether or not each piece of test motion feature data corresponds to the first fitness action according to the standard motion feature data; if each piece of test motion feature data can be accurately determined, determining that a test succeeds; otherwise, adding an input user or adjusting an extraction strategy until the test succeeds.

8. The handle motion counting terminal according to claim 7, wherein in the data input stage, the processor executes the computer program to further implement the following steps:
collecting input physical fitness data of each said input user in real time;
classifying the M pieces of input motion feature data according to different input users to obtain N input motion feature data sets;
taking the input physical fitness data and the input motion feature data set of each said input user as a set of training parameters, and obtaining individual difference data of the first fitness action according to N sets of training parameters, wherein the individual difference data are associations between the physical fitness data and the motion feature data; and
in the data test stage, the processor executes the computer program to implement the following steps:
collecting test physical fitness data of each said test user and test motion feature data of each said test user completing the first fitness action in real time;
obtaining simulated motion feature data of each said test user according to the test physical fitness data of the test user and the individual difference data of the first fitness action;
judging whether or not a difference between the test motion feature data for completing the first fitness action and the simulated motion feature data of each said test user is within a consistency threshold; if so, determining that a test succeeds; otherwise, adding an input user or adjusting an extraction strategy until the test succeeds; and
in an application stage from Step S1 to Step S4, the processor executes the computer program to further implement the following step:
collecting identity information of a user entering an area where the current exercise handle is located in real time; if the identity information of the user indicates that the user enters the area where the current exercise handle is located for the first time, acquiring physical fitness data of the user corresponding to the identity information of the user;
in the application stage from Step S1 to Step S4, the processor executes the computer program to further implement the following steps after Step S4:
using last real-time number as a final number if the real-time number is not updated after a preset interval or a difference between the real-time motion feature data of two successive motions exceeds a preset user threshold, and updating the real-time number to 0;
acquiring identify information of all users in the area where the current exercise handle is located within a whole time period corresponding to the final number to obtain a first identity information set, and acquiring user physical fitness data corresponding to each piece of user identity information in the first identity information set to obtain a first physical fitness data set;
acquiring the individual difference data of the real-time fitness action, and selecting a first user, that best matches the real-time motion feature data, from the first physical fitness data set according to the individual difference data of the real-time fitness action; and
generating a preset interface according to the final number, and sending the preset interface to the first user.

9. The handle motion counting terminal according to claim 8, wherein the processor executes the computer program to implement the step of selecting a first user, that best matches the real-time motion feature data, from the first physical fitness data set according to the individual difference data of the real-time fitness action specifically as follows:
determining whether or not the real-time fitness action is a single-hand operation; if so, acquiring single real-time motion feature data from the real-time motion feature data every time the real-time fitness action is completed, analyzing all the single real-time motion feature data to obtain a single motion track and a single speed variation corresponding to each piece of single real-time motion feature data, obtaining an overall track variation, an overall interval variation and an overall speed variation according to the single motion tracks and the single speed variations of all the single real-time motion feature data, and using the single motion tracks, the single speed variations, the overall track variation, the overall interval variation and the overall speed variation as real-time user recognition data;
extracting user physical fitness data piece by piece from the first physical fitness data set, wherein the user physical fitness data include height, length of arms and legs, and length of upper arms;
determining a matching degree between each piece of user physical fitness data and the real-time user data according to the individual difference data to obtain the first user with highest matching degree; or
if the real-time fitness action is a two-hand operation, acquiring two sets of real-time motion feature data, and obtaining real-time user recognition data including two sets of single motion tracks, single speed variations, overall track variations, overall interval variations and overall speed variations as well as a distance variation of the two sets of real-time motion data at a same time point;
extracting user physical fitness data piece by piece from the first physical fitness data set, wherein the user physical fitness data include height, length of arms and legs, arm span, and length of upper arms; and
determining a matching degree between each piece of user physical fitness data and the real-time user data according to the individual difference data to obtain the first user with a highest matching degree.

10. The handle motion counting terminal according to claim 6, wherein the current exercise handle is a pulling rope handle, a dumbbell handle or a butterfly rope handle.

11. The handle motion counting method according to claim 2, wherein the current exercise handle is a pulling rope handle, a dumbbell handle or a butterfly rope handle.

12. The handle motion counting method according to claim 3, wherein the current exercise handle is a pulling rope handle, a dumbbell handle or a butterfly rope handle.

13. The handle motion counting method according to claim 4, wherein the current exercise handle is a pulling rope handle, a dumbbell handle or a butterfly rope handle.

14. The handle motion counting terminal according to claim 7, wherein the current exercise handle is a pulling rope handle, a dumbbell handle or a butterfly rope handle.

15. The handle motion counting terminal according to claim 8, wherein the current exercise handle is a pulling rope handle, a dumbbell handle or a butterfly rope handle.

16. The handle motion counting terminal according to claim 9, wherein the current exercise handle is a pulling rope handle, a dumbbell handle or a butterfly rope handle.
